(19) United States
(12) Patent Application Publication
(10) Pub. No.: US 2004/0201807 A1
(43) Pub. Date: Oct. 14, 2004

(54) Multi-domain vertical alignment liquid crystal display

(75) Inventor: Hiap L. Ong, Northborough, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Kopin Corporation, Taunton, MA

(21) Appl. No.: 10/698,968

(22) Filed: Oct. 31, 2003

Related U.S. Application Data
(60) Provisional application No. 60/423,621, filed on Nov. 1, 2002.

(51) Int. Cl. G02F 1/1337

(52) U.S. Cl. 349/129

(57) ABSTRACT

A particular multi-domain vertical alignment (MVA) liquid crystal display (LCD) can offer a high contrast ratio and a wide symmetrical viewing angle, without rubbing, protrusion surface, or ITO slit geometry. The viewing angle can be further enlarged by the use of optical compensation films, such as a negative birefringence anisotropic optical film with a vertical optical axis.

### RELATED APPLICATION

This application claims the benefit of U.S. Provisional Application No. 60/423,621, filed on Nov. 1, 2002, the entire teachings of which are incorporated herein by reference.

### BACKGROUND

The market for liquid crystal displays (LCD's) is increasing rapidly, especially in areas of large-area liquid crystal (LC) displays and television applications. The requirements for these applications include high resolutions, very high contrast levels, wide symmetrical viewing angles, and fast response times. In addition, very high contrast levels with respect to different viewing angles, gray-scale inversion, colorimetry, and optical response of a LCD are important factors of high quality LCD's. The cost associated with designing and manufacturing these LCD's, based on the above-mention requirements, also needs to be considered.

Controlling liquid crystal domains is the most important technology in obtaining a wide-viewing angle for a vertically aligned LCD's. Most of the conventional LCD's are 90° twisted nematic (TN) liquid crystal material in an LCD panel with crossed polarizers attached outside. The drawbacks of the conventional LCD's include narrow viewing angles (±40° horizontally and −15° and +30° vertically), slow response times (about 40 ms), large color dispersion, and difficulty in manufacturing high quality LCD's based on a conventional rubbing process.

The conventional rubbing process involves rubbing a polyimide film with a cloth attached to a rotational roller. This process may cause damage to TFT devices and bus lines through mechanical and electrical static discharge (ESD). It also creates cloth-fiber particles and polyimide flakes which must be removed by post-rubbing cleaning which increases the number of process steps.

To address the aforementioned problems, a multi-domain vertical alignment (MVA) mode LCD having a high contrast level, and a wide symmetrical viewing angle has been developed. The conventional rubbing process is difficult to use to mass-produce MVA-LCD because of low-yield, high-cost multiple rubbing processes, unstable low-pre-tilt vertical alignment, and low contrast ratio for displays using a titled vertical LC alignment. Thus, a vertical LC alignment with a zero-degree pre-tilt angle is used along with special surface geometries, such as a protrusion surface, ITO slit geometry, or a protrusion surface combined with ITO slit geometry to control the LC molecule orientation automatically. Depending on single or double protrusion surfaces, either two-domain or four-domain MVA's can be created to improve the optical performances. Protrusions and ITO slits contribute to an MVA-LCD having a low transmittance. Also, these protrusions and ITO slits contribute to a high cost of production. The combination of a protrusion surface with an ITO split geometry provides a better control on the MVA-LCD, but requires a good alignment on the top and bottom substrates.

### SUMMARY

A particular multi-domain vertical alignment (MVA) liquid crystal display (LCD) can offer a high contrast ratio and a wide symmetrical viewing angle, without rubbing, protrusion surface, or ITO slit geometry. The viewing angle can be further enlarged by the use of optical compensation films, such as a negative birefringence anisotropic optical film with a vertical optical axis.

A multi-domain vertical alignment display includes a liquid crystal display device having a fringe field associated with each pixel of the device, the fringe field in each pixel being substantially used to control the liquid crystal tilt direction to create the multi-domain vertical alignment display. The liquid crystal tilt direction can be controlled by a driving scheme to create a multi-domain vertical alignment domain profile. The driving scheme can be a column inversion driving scheme, a row inversion driving scheme, or a pixel inversion driving scheme. The pixel inversion driving scheme creates a four-domain vertical alignment display while the column inversion and the row inversion driving schemes create a two-domain vertical alignment display.

The display can have boundary lines to reduce or eliminate the fringe field from extending into neighboring pixels. The boundary lines can be maintained at a reference voltage. The reference voltage can be ground potential or the common electrode voltage.

The display can be improved by using an optical compensation film to improve the viewing angle of the display. The optical compensation film can be a negative birefringence anisotropic optical film, a uniaxial film, or a biaxial film.

The multi-domain vertical alignment display can be a multi-domain homogeneous (parallel) liquid crystal display, a multi-domain twisted nematic liquid crystal display, a transmissive-type liquid crystal display, a reflective-type liquid crystal display, a transflective-type liquid crystal display, or a hybrid-oriented nematic liquid crystal display.

### BRIEF DESCRIPTION OF THE DRAWINGS

The foregoing and other objects, features and advantages of the Multi-Domain Vertical Alignment Liquid Crystal Display will be apparent from the following more particular description of particular embodiments, as illustrated in the accompanying drawings in which like reference characters refer to the same parts throughout the different views. The drawings are not necessarily to scale, emphasis instead being placed upon illustrating the principles of the invention.

FIG. 1A shows a MVA-LCD according to the prior art.

FIG. 1B shows a cross-sectional diagram of the device shown in FIG. 1A.

FIG. 2A shows a particular vertical orientated nematic LCD according to principals of the present invention.

FIG. 2B illustrates a vertical LC molecule orientation when the device of FIG. 2A is in the “field-off” state.

FIG. 2C illustrates a tilted LC molecule orientation when the device of FIG. 2A is in the “field-on” state.

FIG. 3 is a schematic of the four types of driving schemes.

FIG. 4 shows a particular 4-domain pixel image, under pixel inversion with crossed-polarizers.

FIG. 5 shows a particular 2-domain pixel image, under column inversion with crossed-polarizers.

FIG. 6 shows the vertical orientated nematic LCD of FIG. 2A with boundary lines.

FIG. 7A is a graph of transmission verse voltage for a fabricated display under pixel inversion using alignment material SE-1211.

FIG. 7B is a graph of transmission verse contrast ratio for a fabricated display under pixel inversion using alignment material SE-1211.

### DETAILED DESCRIPTION

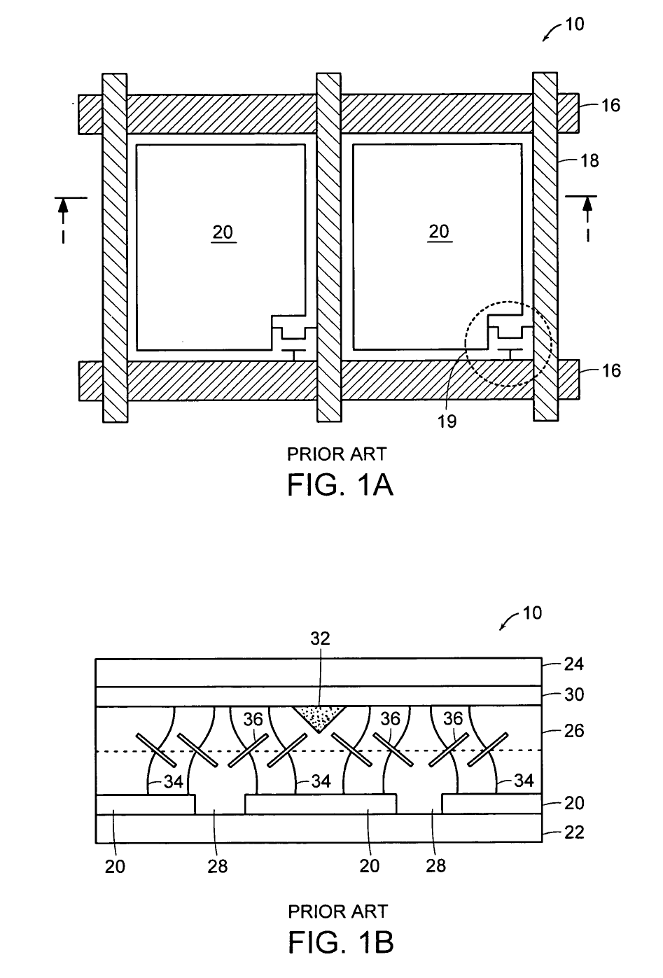

FIG. 1A is a top view showing one type of a MVA-LCD according to the prior art. FIG. 1B is a sectional diagram along line I-I shown in FIG. 1A. The conventional MVA-LCD 10 has two parallel substrates 22, 24, and a liquid crystal (LC) layer 26 formed in the space between the two parallel substrates 22, 24. Substrate 22 may be a thin film transistor (TFT) array substrate (as shown) and substrate 24 may be a color filter substrate or an ITO substrate. On substrate 22, a plurality of transverse-extending scanning electrodes 16 and a plurality of lengthwise-extending signal electrodes 18 define square-shaped pixel areas arranging in a matrix form. Each of the pixel areas is covered by a pixel electrode 20, and has a TFT structure 19 near the intersection of the scanning electrode 16 and the signal electrode 18. Also, ITO slits 28 are formed in the substrate 22.

On substrate 24, a plurality of common electrodes 30 are formed on a glass substrate to pass through pixel areas. Also, at least one lengthwise-extending protrusion 32 is formed on the common electrode 30.

The profile of the protrusion 32 and the ITO slits 28 can contribute to a multi-domain cell through a combination of pre-tilt control and an electric field 34 applied between the two substrates 22, 24. For LC molecules 36 near the sidewalls of the protrusion 32, the slope of the protrusion 32 causes the LC molecules 36 to tilt in a desired direction either when the electric field 34 is applied across the pixel area or not. For the LC molecules 36 away from the sidewalls of the protrusion 32, the slope of the protrusion 32 and the electric field 34 formed from the ITO slits 28 cause the LC molecules 36 to tilt in a desired direction when the electric field 34 is applied across the pixel area.

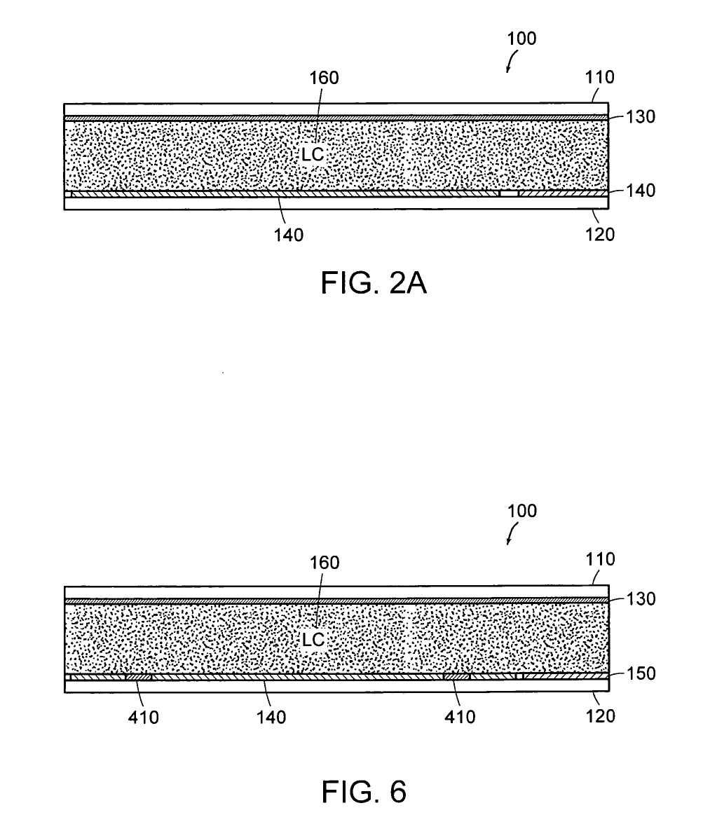

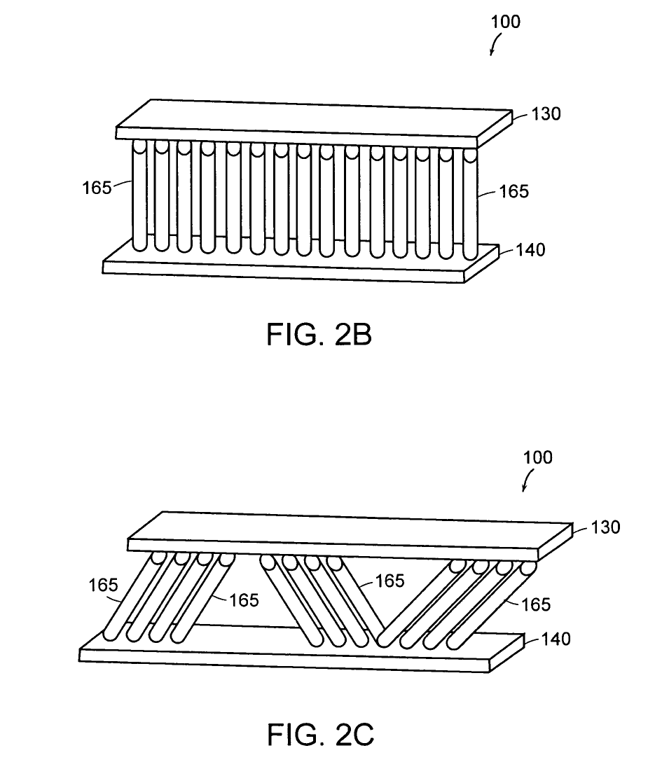

Generally, a particular multi-domain vertical alignment liquid crystal display (MVA-LCD) 100 according to principals of the present invention is shown in FIGS. 2A-2C. The vertical surface alignment of the MVA-LCD 100 was achieved without rubbing. The MVA-LCD 100 includes liquid crystal (LC) material 160 disposed between a first and second substrate 110, 120. A common electrode 130 is formed on the substrate 110, and a plurality of pixel electrodes 140 are formed on the second substrate 120.

Each substrate 110, 120 is treated such that a vertical LC alignment with a zero-degree pre-tilt angle is created without rubbing. Conventional non-rubbing vertical surface alignments can be used for this application. Types of LC alignment materials used in this process are commercially available from Japan Nissan Chemical Industrial Limited, such as polyimide materials SE-7511L, SE-1211 and RN-1566. The alignment layer can also be fabricated by a photo-alignment process as described in “Optical patterning of multi-domain LCDs” by M Schadt and H Seiberle, SID Digest, 397 (1997), the entire teachings of which are incorporated herein by reference.

An LC material 160 with a negative dielectric anisotropy can be used between the two substrates 110, 120. Types of LC materials are commercially available from Merck, such as Merck MLC-6608, MLC-6609, MLC-6610, MLC-6682, MLC-6683, MLC-6684, MLC-6685 and MLC-6686.

In general, for a vertical alignment LC, there is no preferred alignment direction on the tilt angle in the “field-on” state. A normal electric field is applied between the first and second substrates 110, 120 to switch the LC material 160 from an initial vertical orientation (FIG. 2B) to a tilted orientation (FIG. 2C), and a fringe field associated with each pixel 20 is used to control the LC tilt direction and create the MVA-LCD.

A “field-off” state is the state of the MVA-LCD 100 when no electric field is applied between the first and second substrates 110, 120. FIG. 2B illustrates a vertical LC molecule orientation when the device of FIG. 2A is in the “field-off” state. A “field-on” state is the state of the MVA-LCD 100 when an electric field is applied between the first and second substrates 110, 120. FIG. 2C illustrates a tilted LC molecule orientation when the device of FIG. 2A is in the “field-on” state. Thus, in a “field-on” state, the electric field switches the LC molecules 165 from the initial vertical orientation to a tilted orientation. The LC tilt direction is controlled by the fringe field direction associated with each pixel 20. Across each pixel 20, the fringe field direction changes in the opposite direction, the LC tilt angle changes direction across each pixel 20, and thus creates multiple LC domains, separated by a LC domain wall with a vertical orientation.

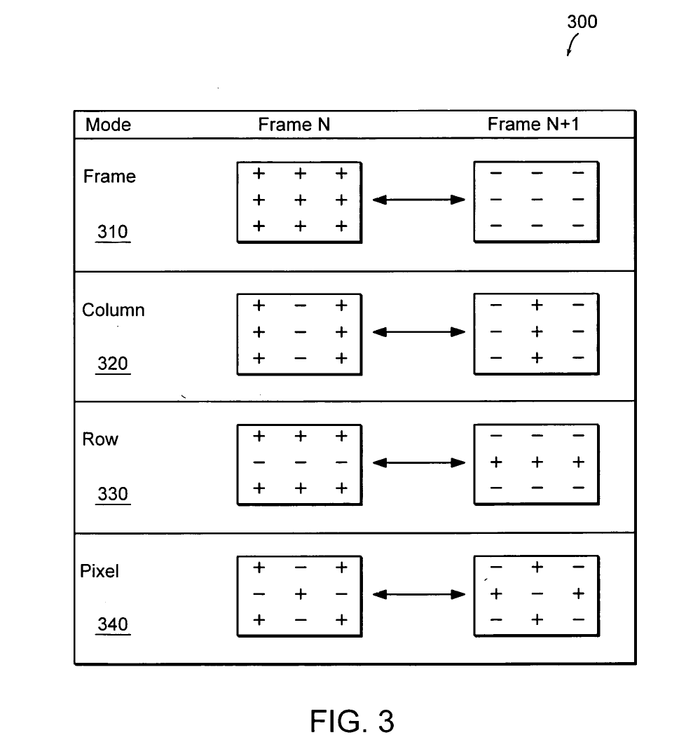

FIG. 3 shows the schematics of four types of driving schemes: frame inversion 310, column inversion 320, row inversion 330, and pixel inversion 340 for active matrix addressed TFT/LCD's. The MVA LC profile of the present invention can be achieved under column inversion 320, row inversion 330 and pixel inversion 340 because sufficiently strong fringe fields in the opposite directions are present in each pixel under in these driving schemes. However, frame inversion 310 cannot be used with the principals of the present invention because only one polarity exists at any given time.

A 2-domain MVA profile can be obtained under row inversion and column inversion driving schemes (330, 320 respectively) while a 4-domain MVA profile can be obtained under the pixel inversion driving scheme 340. A multi-domain profile, such as a 2 and 4 MVA domain profile, can be obtained by alternating between the pixel inversion driving scheme 340 and the column inversion driving scheme 320 or row inversion driving scheme 330.

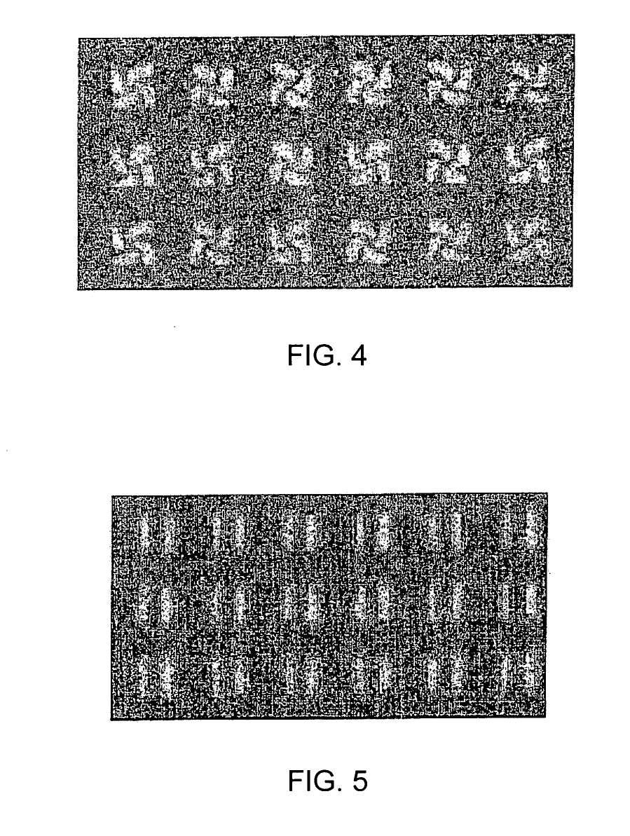

Using the pixel inversion driving scheme 340, each pixel has a different polarity with respect to its 4 adjacent pixels, that is the left, right, up and down pixels. Thus, in each pixel, under the fringe field effect, four different domains are formed in the left, right, up, and down pixel regions, where the LC molecules in the left, right, up, and down domains tilt in the left, right, up, and down directions respectively. FIG. 4 shows a particular 4-domain pixel image, under pixel inversion with crossed-polarizers.

Using the column inversion driving scheme 320, each pixel has a different polarity with respect to its adjacent left and right pixels. Thus, in each pixel, under the fringe field effect, two different domains are formed in the left and right pixel regions, where the LC molecules in the left domain tilt in the left direction and the LC molecules in the right domain tilt in the opposite right direction. FIG. 5 shows a particular 2-domain pixel image, under column inversion with crossed-polarizers.

Using the row inversion driving scheme 320, each pixel has a different polarity with respect to its adjacent up and down pixels. Thus, in each pixel, under the fringe field effect, two different domains are formed in the up and down pixel regions, where the LC molecules in the up domain tilt in the up direction and the LC molecules in the down domain tilt in the opposite down direction. The 2-domain pixel image, under row inversion with crossed-polarizers would be similar to a 90 degree rotated image of FIG. 5.

In some instances, the fringe field associated with surrounding pixels may create cross-talk and image sticking effects thereby reducing the quality of the image. Alternatively, boundary lines 410 can be formed to reduce or eliminate the fringe field from extending into neighboring pixels. FIG. 6 shows the vertical orientated nematic LCD of FIG. 2A with boundary lines. The boundary lines 410 can be maintained at a reference voltage, such as ground potential or the common electrode voltage. Boundary lines 410 can be used for any type of display to improve image quality.

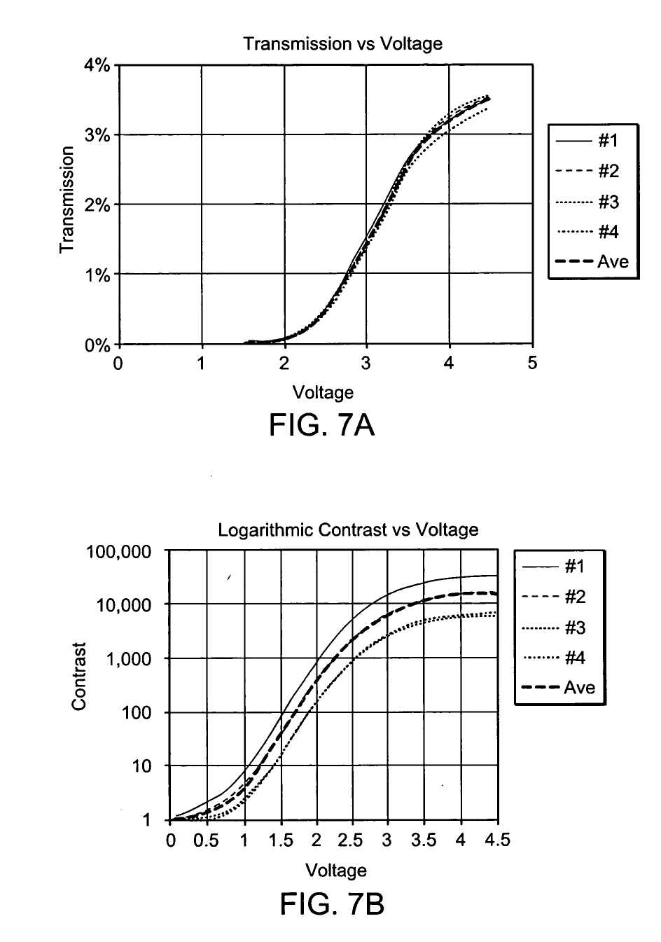

The MVA-LCD of the present invention provides for high contrast, symmetrical viewing-angle LC optical performance, improved gray scale operation, and an improved small gray scale reverse region. FIG. 7B shows the measured contrast ratio vs. voltage for four fabricated MVA-LCD's.

A wide symmetrical viewing angle is obtained by the multi-domain LC profile. Further, the viewing angle of the MVA-LCD can be further improved by the use of optical compensation films, such as a negative birefringence anisotropic optical film with a vertical optical axis. Both uniaxial and biaxial optical compensation films, with a positive or negative birefringence, or composite film with positive and negative birefringence's, can be used to improve the viewing angle for the MVA-LCD. Furthermore, the optical axis can either be vertical, parallel, tilted, or a composite film with a variable optical axis structure. For example, an optical compensation film with an ordinary refractive index no=11.51, extra-ordinary refractive index ne=1.50, thickness d=19.4 um, (ne−no)×d=−194 nm, and a vertical optical axis can be applied to substrates 110, 120 to improve performance.

The optical transmission of the MVA can be improved by a higher drive voltage, LC's with a lower threshold voltage, LC's with a high birefringence value, a modified pixel design, and/or the use of circular polarizers. FIG. 7A shows the measured transmission vs. voltage for four fabricated MVA-LCD's. The current transmission for the described MVA-LCD is about 3.5 to 5%, but could be improved to greater than 15%.

The intrinsic fringe field of each associated pixel is used to create MVA profiles according to the present invention. However, relative fringe field effects are smaller in large pixel displays. For large pixel displays (approximately >50 μm), segmentation of the pixel can be used to enlarge the fringe field in each sub-pixel and obtain a MVA-LCD. In addition, different drive polarity can apply to the sub-pixel segment to have polarity reversal in each segment compared to its adjacent segment.

Modeling and experimental results are further detailed in U.S. Provisional Application No. 60/423,621, filed on Nov. 1, 2002 and Ong et al., “New Multi-Domain Vertical Alignment LCD with High Contrast Ratio and Symmetrical Wide Viewing Angle Performance and Simplest Fabrication Design and Process”, SID Digest, 119 (2003), the entire teachings of which are incorporated herein by reference.

The principals of the present invention can be used in a monochromatic liquid crystal display, a color display, a multi-domain homogeneous (parallel) liquid crystal displays, multi-domain twisted nematic liquid crystal displays, transmissive-type liquid crystal displays, reflective-type liquid crystal displays, transflective-type liquid crystal displays, hybrid-oriented nematic liquid crystal displays, displays having a finite twist angle for a non-zero pre-tilt alignment, and MVA devices using ITO split geometry, protrusion surfaces or a combination of ITO split geometry with protrusion surfaces.

While this invention has been particularly shown and described with references to preferred embodiments thereof, it will be understood by those skilled in the art that various changes in form and details may be made therein without departing from the scope of the invention encompassed by the appended claims.

What is claimed is:

1. A multi-domain vertical alignment display, comprising:
a liquid crystal display device having a fringe field associated with each pixel of the device, the fringe field in each pixel being substantially used to control the liquid crystal tilt direction to create the multi-domain vertical alignment display.

2. The multi-domain vertical alignment display of claim 1, wherein the liquid crystal tilt direction is controlled by a driving scheme to create a multi-domain vertical alignment domain profile.

3. The multi-domain vertical alignment display of claim 2, wherein the driving scheme is a column inversion driving scheme, a row inversion driving scheme, or a pixel inversion driving scheme.

4. The multi-domain vertical alignment display of claim 3, wherein the pixel inversion driving scheme creates a four-domain vertical alignment display.

5. The multi-domain vertical alignment display of claim 3, wherein the column inversion and the row inversion driving schemes create a two-domain vertical alignment display.

6. The multi-domain vertical alignment display of claim 3, further comprising boundary lines to reduce or eliminate the fringe field from extending into neighboring pixels.

7. The multi-domain vertical alignment display of claim 6, wherein the boundary lines are maintained at a reference voltage.

8. The multi-domain vertical alignment display of claim 7, wherein the reference voltage is ground potential.

9. The multi-domain vertical alignment display of claim 1, further comprising an optical compensation film to improve the viewing angle of the display.

10. The multi-domain vertical alignment display of claim 9, wherein the optical compensation film is a negative birefringence anisotropic optical film.

11. The multi-domain vertical alignment display of claim 9, wherein the optical film is a uniaxial film or a biaxial film.

12. The multi-domain vertical alignment display of claim 1, wherein the multi-domain vertical alignment display is a monochromatic liquid crystal display, a color display, a multi-domain homogeneous (parallel) liquid crystal display, a multi-domain twisted nematic liquid crystal display, a transmissive-type liquid crystal display, a reflective-type liquid crystal display, a transflective-type liquid crystal display, or a hybrid-oriented nematic liquid crystal display.

13. A method of creating a multi-domain vertical alignment display, comprising:
in a liquid crystal display device having a fringe field associated with each pixel of the device, substantially controlling the liquid crystal tilt direction in each pixel using the fringe field to create the multi-domain vertical alignment display.

14. The method of claim 13, wherein controlling includes a driving scheme to create a multi-domain vertical alignment domain profile.

15. The method of claim 14, wherein the driving scheme is a column inversion driving scheme, a row inversion driving scheme, or a pixel inversion driving scheme.

16. The method of claim 15, wherein the pixel inversion driving scheme creates a four-domain vertical alignment display.

17. The method of claim 15, wherein the column inversion driving scheme or the row inversion driving scheme creates a two-domain vertical alignment display.

18 The method of claim 15, further comprising reducing or eliminating the fringe field from extending into neighboring pixels.

19. The method of claim 18, wherein reducing or eliminating the fringe field includes installing boundary lines between the neighboring pixels.

20. The method of claim 19, wherein the boundary lines are maintained at a reference voltage.

21. The method of claim 20, wherein the reference voltage is ground potential.

22. The method of claim 13, further comprising adding an optical compensation film to the display to improve the viewing angle of the display.

23. The method of claim 22, wherein the optical compensation film is a negative birefringence anisotropic optical film.

24. The method of claim 22, wherein the optical film is a uniaxial film or a biaxial film.

25. The method of claim 13, wherein the multi-domain vertical alignment display is a monochromatic liquid crystal display, a color display, a multi-domain homogeneous (parallel) liquid crystal display, a multi-domain twisted nematic liquid crystal display, a transmissive-type liquid crystal display, a reflective-type liquid crystal display, a transflective-type liquid crystal display, or a hybrid-oriented nematic liquid crystal display.

26. A multi-domain vertical alignment display, comprising:
a first substrate and a second substrate;
a plurality of rows and a plurality of columns formed on the second substrate, the intersection of which forming a plurality of pixels;
liquid crystal material disposed between the first and second substrates, liquid crystal molecules having a vertical orientation and each pixel having an associated fringe field when an electric field is applied between the first substrate and the second substrate; and
a controller for substantially providing a tilted orientation of the liquid crystal molecules only the fringe field associated with each pixel.

27. The multi-domain vertical alignment display of claim 26, wherein the controller utilizes a driving scheme to create a multi-domain vertical alignment domain profile.

28. The multi-domain vertical alignment display of claim 27, wherein the driving scheme is a column inversion driving scheme, a row inversion driving scheme, or a pixel inversion driving scheme.

29. The multi-domain vertical alignment display of claim 28, wherein the pixel inversion driving scheme creates a four-domain vertical alignment display.

30. The multi-domain vertical alignment display of claim 28, wherein the column inversion and the row inversion driving schemes create a two-domain vertical alignment display.

31. The multi-domain vertical alignment display of claim 28, further comprising boundary lines to reduce or eliminate the fringe field from extending into neighboring pixels.

32. The multi-domain vertical alignment display of claim 31, wherein the boundary lines are maintained at a reference voltage.

33. The multi-domain vertical alignment display of claim 32, wherein the reference voltage is ground potential.

34. The multi-domain vertical alignment display of claim 26, further comprising an optical compensation film to improve the viewing angle of the display.

35. The multi-domain vertical alignment display of claim 34, wherein the optical compensation film is a negative birefringence anisotropic optical film.

36. The multi-domain vertical alignment display of claim 34, wherein the optical film is a uniaxial film or a biaxial film.

37. The multi-domain vertical alignment display of claim 26, wherein the multi-domain vertical alignment display is a monochromatic liquid crystal display, a color display, a multi-domain homogeneous liquid crystal display, a multi-domain twisted nematic liquid crystal display, a multi-domain parallel liquid crystal display, a transmissive-type liquid crystal display, a reflective-type liquid crystal display, a transflective-type liquid crystal display, or a hybrid-oriented nematic liquid crystal display.

38. A method of creating a multi-domain vertical alignment display, comprising:
providing a first substrate and a second substrate;
forming a plurality of pixels on the second substrate;
disposing liquid crystal material between the first and second substrates, liquid crystal molecules having a vertical orientation and each pixel having an associated fringe field when an electric field is applied between the first substrate and the second substrate; and
substantially controlling a tilted orientation of the liquid crystal molecules using the fringe field associated with each pixel.

39. The method of claim 38, wherein controlling includes a driving scheme to create a multi-domain vertical alignment domain profile.

40. The method of claim 39, wherein the driving scheme is a column inversion driving scheme, a row inversion driving scheme, or a pixel inversion driving scheme.

41. The method claim 40, wherein the pixel inversion driving scheme creates a four-domain vertical alignment display.

42. The method of claim 40, wherein the column inversion and the row inversion driving schemes create a two-domain multi-domain vertical alignment display.

43. The method of claim 40, further comprising reducing or eliminating the fringe field from extending into neighboring pixels.

44. The method of claim 43, wherein reducing or eliminating the fringe field includes installing boundary lines between the neighboring pixels.

45. The method of claim 44, wherein the boundary lines are maintained at a reference voltage.

46. The method of claim 45, wherein the reference voltage is ground potential.

47. The method of claim 38, further comprising adding an optical compensation film to improve the viewing angle of the display.

48. The method of claim 47, wherein the optical compensation film is a negative birefringence anisotropic optical film.

49. The method of claim 47, wherein the optical film is a uniaxial film or a biaxial film.

50. The method of claim 38, wherein the multi-domain vertical alignment display is a monochromatic liquid crystal display, a color display, a multi-domain homogeneous (parallel) liquid crystal display, a multi-domain twisted nematic liquid crystal display, a transmissive-type liquid crystal display, a reflective-type liquid crystal display, a transflective-type liquid crystal display, or a hybrid-oriented nematic liquid crystal display.

51. A multi-domain vertical alignment display, comprising:
means for substantially controlling the LC tilt direction in each pixel of the display using a fringe field associated with each pixel.
